(19) United States
(12) Patent Application Publication
(10) Pub. No.: US 2022/0318880 A1
(43) Pub. Date: Oct. 6, 2022

(54) SYSTEM AND METHOD FOR PROVIDING A RELEVANT PRODUCT VIA A DIGITAL MEDIA PLATFORM

(71) Applicant: FLIPKART INTERNET PRIVATE LIMITED, Bengaluru (IN)

(72) Inventors: Seema Saroha, Bengaluru (IN); Lakshmisha KS, Bengaluru (IN)

(73) Assignee: FLIKPART INTERNET PRIVATE LIMITED, Bengaluru (IN)

(21) Appl. No.: 17/550,813

(22) Filed: Dec. 14, 2021

(30) Foreign Application Priority Data
Mar. 30, 2021 (IN) 202141014354

(51) Int. Cl. G06Q 30/06; G06Q 50/00; G06F 16/9535

(52) U.S. Cl. CPC G06Q 30/0625; G06Q 50/01; G06F 16/9535

(57) ABSTRACT

The present disclosure provides a method [200] and system [100] for providing a relevant product via a digital media platform. The method comprises receiving, a user query of a user. The method thereafter comprises determining, a personalization score corresponding to the user query based at least on an affinity of the user to digital content/s and influencer/s present on social media platform/s. The method thereafter encompasses determining, a diversification score corresponding the digital content/s. Further the method comprises determining, a relevance score of standard relevance parameter/s corresponding to the user query. The method thereafter encompasses determining, a ranking score corresponding to the user query based at least on the personalization score, the diversification score and the relevance score. The method thereafter encompasses providing via the digital media platform, the relevant product in response to the user query based on the ranking score corresponding to the user query.

### TECHNICAL FIELD

The present invention generally relates to the field of digital platforms and more particularly, to a system and method for providing via a digital media platform relevant products, influencers and/or influencer content in response to a user query.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The Internet began its journey as a way to connect different people and systems, and various digital platforms such as an ecommerce platform, a social media platform and the like are the natural evolution of the Internet. Generally, ecommerce platforms connect a multitude of buyers and sellers digitally, and social media platforms connect various users and influencers digitally. Furthermore, ecommerce platforms today offer a wide range of selection, convenience, and differential value to consumers/users which are driving its adoption higher year after year. On the other hand, social media platforms are catering to unique user needs such as by providing a platform to communicate with various users digitally. However, such social media platforms may also provide facilities such as sale and purchase of various products, accessing information related to various products and/or users such as influencers, and the like. Furthermore, social shopping or social commerce is the natural evolution of combining the two powerful trends i.e., a shift in commerce to the digital platforms and explosive growth of digital social interaction by users. Furthermore, to assist social shopping or social commerce, digital media platforms (for instance, the social media platforms) usually consist of users, products that are available for shopping, and partners (or other users/influencers) who provide online social input to the users via posting various modes of digital content on the digital media platforms. More particularly, the influencers are the users who generally provide two main services i.e., curation of products/selection and content about products or commerce itself, to other users present on the digital media platforms.

Furthermore, to provide the users/customers information related to one or more products via a digital media platform and/or to provide the users a personalized experience on the digital media platform, various parameters are considered by the currently known solutions. For instance, the one or more products may be suggested to the user/s based on a selection of top-selling product/s on the digital media platform in conjunction with a profile of the user/s, and/or based on a past purchase behavior of the user/s as a means to predict future purchase intentions. Also, the personalization of search results can be achieved by comparing a content similarity between the user/s and an available search selection. The topical interest of the user/s can be explicitly availed from the user/s as an input or can be learned over time based on a user interaction data of the user/s associated with the one or more digital media platforms. In one other instance, standard user profiles can be created via a digital media platform basis at least user/s behavioral inputs to personalize search results, such as for every new user, basis the user interaction data, the user can be boxed into a specific profile basis affinity. Thereafter in the given instance, the personalization is provided by serving content suitable to the matching profile. Furthermore, by currently known solutions, personalization for a user may be provided based on a determined set of customers/users whose purchase behavior is similar to a target user and an aggregate purchase basket, to further suggest items to the target user excluding the ones already purchased by the target user. Also, in other known solutions, item-to-item collaborative filtering may be used to power personalization. For instance, in such known solutions, based on the purchase history of millions of customers/users, item-to-item affinity score for each item with an entire set of items available in a catalogue is calculated. Furthermore, basis the customer's recent purchase behavior and interactions, the known solution recommends product/s which have the highest affinity with items the customer has recently purchased. Further, such item-to-item personalization doesn't take into account the interconnectedness between various digital (such as social media) contents, therefore has various limitations and failed to provide an efficient personalization to the users on various digital media platforms. Hence there is a need to solicit inputs from the user's interaction with an entire range of digital contents/social media contents, to provide proper and specific personalization.

Furthermore, diversification is also important while providing an information related to various contents over the digital media platforms as showcasing diverse content, influencers, products and other information are important to ensure at least the customer engagement on the digital media platform. Therefore, the currently known solutions attempt to remove repetitive results and produce a diverse result set relevant to a user query, but such solutions are not efficient and fails to provide diversification according to user's requirements. Furthermore, as the customers/users desire to find relevant products that they may be interested in purchasing or relevant content/influencers that they may be interested in consuming/engaging, these arises a need to provide a solution to provide a relevant search result to the users while catering to diverse preferences of the users which can change with time.

Furthermore, the currently known solutions also fail to provide a relevant output to the user/s from four distinct asset sets (i.e., products, partners (influencers/stores/etc.), digital content from the partners, and hashtags) present on the digital media platforms. The current solutions fail to assist in expediting fulfilment of customer intent that could be - to purchase products, to view content, to explore/engage with partners (influencers), to explore hashtags etc. Furthermore, the known solutions also fail to determine personalization scores for a user based on a user affinity to social/digital contents present on the digital media platforms, to fulfil the aspects of personalization. Also, the known solutions fail to determine diversification scores for digital media contents, products, and influencers etc., to efficiently solve the problem of diversification of digital search results. Furthermore, the known solutions also fail to provide the users a relevant information in response to a user query, based on different parameters such as at least one of a relevance score, a personalization score, a diversification score, a performance score, a quality score, a speed score etc.

Therefore, there is need in the art to provide a solution that uses personalization, diversification and other relevance parameters corresponding to a user query, to efficiently and effectively provide a relevant information/product via a digital media platform, in response to the user query.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a system and method for providing a relevant product, influencer and/or influencer content via a digital media platform, in response to a user query. Another object of the present invention is to provide a solution for providing an information based on personalization, diversification, and ranking of a search result (such as products/ influencers/ influencers contents etc.) on a digital media platform. Another object of the present invention is to determine personalization scores corresponding to a user query based on user affinities to at least one of digital content, influencer, products and/or tags (i.e., hashtags), to further provide personalized search results in response to the user query. Also, an object of the present invention is to provide a solution for diversification problems related to digital search of an information such as contents posted on digital media platforms, details of products and/or influencers present on digital media platforms etc., based on a diversification score determined for such digital search. Another object of the present invention is to combine one or more personalization and diversification parameters with traditional search ranking parameters in a way an efficient and effective information/product is provided to the users in response to one or more user queries. Yet another object of the present invention is to provide ranking of a product/digital content/influencer based on personalization and diversification parameters such as by keeping different weights for personalization parameters, diversification parameters, and at least one of one or more performance, quality, speed and the like parameters.

In order to achieve the aforementioned objectives, the present invention provides a method and system for providing a relevant product via a digital media platform, in response to a user query.

An aspect of the present invention relates to a method for providing at least one of a relevant product, influencer and influencer content via a digital media platform, in response to a user query. The method comprises receiving, at a transceiver unit, the user query of a user. The method thereafter comprises determining, by a processing unit, a personalization score corresponding to the user query based at least on an affinity of the user to one or more digital contents and one or more influencers present on one or more social media platforms. The method thereafter encompasses determining, by the processing unit, a diversification score corresponding the one or more digital contents/products. Further the method comprises determining, by the processing unit, a relevance score of one or more standard relevance parameters corresponding to the user query. Also, the method thereafter leads to determining, by the processing unit, a ranking score corresponding to the user query based at least on the personalization score, the diversification score and the relevance score. The method thereafter encompasses providing, by the processing unit via the digital media platform, at least one of the relevant product, influencer and influencer content in response to the user query based on the ranking score corresponding to the user query.

Another aspect of the present invention relates to a system for providing at least one of a relevant product, influencer and influencer content via a digital media platform, in response to a user query. The system comprises a transceiver unit, configured to receive, the user query of a user. Further, the system comprises a processing unit, configured to, determine a personalization score corresponding to the user query based at least on an affinity of the user to one or more digital contents and one or more influencers present on one or more social media platforms. The processing unit is thereafter configured to determine a diversification score corresponding the one or more digital contents/products. Further, the processing unit is configured to determine a relevance score of one or more standard relevance parameters corresponding to the user query. Also, the processing unit is thereafter configured to determine a ranking score corresponding to the user query based at least on the personalization score, the diversification score and the relevance score. Thereafter, the processing unit is configured to provide via the digital media platform, at least one of the relevant product, influencer and influencer content in response to the user query based on the ranking score corresponding to the user query.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components,

FIG. 1 illustrates an exemplary block diagram of a system [100] for providing a relevant product via a digital media platform, in response to a user query, in accordance with exemplary embodiments of the present invention.

FIG. 2 illustrates an exemplary method flow diagram [200], depicting a method for providing a relevant product via a digital media platform, in response to a user query, in accordance with exemplary embodiments of the present invention.

The foregoing shall be more apparent from the following more detailed description of the disclosure.

### DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, a storage unit, a display unit, a transceiver unit and any other such unit(s) which are obvious to the person skilled in the art and are capable of implementing the features of the present disclosure.

As used herein the “Transceiver Unit” may include but not limited to a transmitter to transmit data to one or more destinations and a receiver to receive data from one or more sources. Further, the Transceiver Unit may include any other similar unit obvious to a person skilled in the art, to implement the features of the present invention. The transceiver unit may convert data or information to signals and vice versa for the purpose of transmitting and receiving respectively.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, the existing technologies have many limitations and in order to overcome at least some of the limitations of the prior known solutions, the present disclosure provides a solution for providing at least one of a relevant product, influencer and influencer content via a digital media platform, in response to a user query. More particularly, the present invention provides via the digital media platform an information related to products that are available for shopping, influencers (i.e. users who provide online social input to other users via various modes of digital contents), and influencers content (i.e. the digital content posted by the influencers) etc. The term “content” and/or “digital content” refers to a content posted on one or more digital media platforms (such as at least one of an ecommerce platform and a social media platform). Also, such content may be posted in form of at least one of a text data, an image data, a video data and such other data formats. Furthermore, the present invention provides the users via the digital media platform a relevant output in response to the user query, based on four distinct asset sets i.e., products, influencers (partners/store/etc.), influencers content, and hashtags, present on one or more social media platforms. In an implementation the user query may be a search query initiated by a user to search one or more products on the digital media platform. Also, in an implementation the user query may also comprises a search query for at least one of one or more influencers, one or more influencers content, one or more hashtags and the like data. Further, in other implementation the user query may be a user intent determined based on a user interaction data associated with the digital media platform. Also, in an instance the digital media platform may be same as that of a social media platform and in another instance the digital media platform may be an ecommerce platform linked to the social media platform/s.

More particularly, the present invention firstly encompasses determining a personalization score corresponding to user query of user/s based at least on the users' affinity to social/digital contents present on the social media platforms, to fulfil the aspects of personalization. Thereafter, the present invention comprises determining a diversification score for one or more products to solve the problem of diversification of digital search. Also, in an instance the present invention may also encompasses determining a diversification score for one or more digital contents and one or more influencers present on the social media platforms. The present invention thereafter encompasses use of weights for different ranking parameters such as one or more relevance scores, one or more determined personalization scores, one or more determined diversification scores, one or more performance scores, one or more quality scores, one or more speed scores and/or the like, to provide in response to the user query/user intent, a relevant information such as at least one of a relevant product, a relevant influencer, a relevant digital content, a relevant tag (i.e. hashtag) and the like data via the digital media platform.

Therefore, the present invention provides a solution to provide a relevant information such as at least one of a relevant product, a relevant influencer, a relevant digital content, a relevant tag via a digital media platform in response to a user query, which further assist in expediting fulfilment of customer/user intent that could be to purchase product/s, to view digital content/s, to explore/engage with influencers, to explore hashtags and the like, via the digital media platform.

The present disclosure is further explained in detail below with reference now to the drawings.

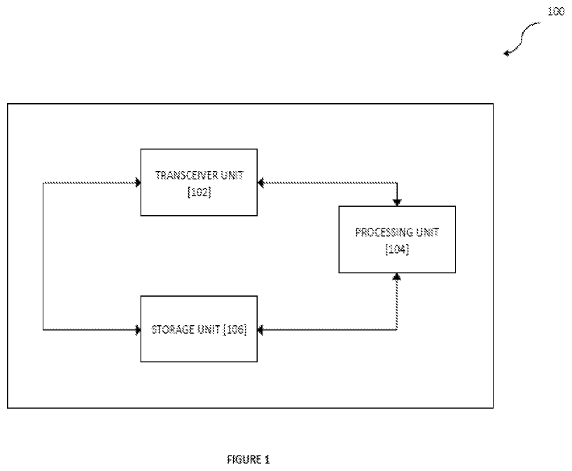

Referring to FIG. 1, an exemplary block diagram of a system [100] for providing a relevant product via a digital media platform, in response to a user query, in accordance with exemplary embodiments of the present invention is shown. As shown in FIG. 1, the system encompasses at least one transceiver unit [102], at least one processing unit [104] and at least one storage unit [106]. In an implementation, the system [100] may reside in a server device connected to a user device. In another implementation the system [100] may reside in the user device and in yet another implementation the system [100] may resides in parts in the user device and the server device. All of the components/ units of the system [100] are assumed to be connected to each other unless otherwise indicated below. Also, in FIG. 1 only a few units are shown, however, the system [100] may comprise multiple such units or the system [100] may comprise any such numbers of said units, obvious to a person skilled in the art or as required to implement the features of the present disclosure.

The system [100] is configured to provide the relevant product via the digital media platform, in response to the user query, with the help of the interconnection between the components/ units of the system [100].

The transceiver unit [102] is configured to receive, the user query of a user. In an implementation the user query is a search query initiated by the user for searching at least a relevant product, via the digital media platform. Also, the user query may be initiated by the user to search an information of at least one of one or more relevant influencers and one or more relevant digital contents (such as one or more relevant hashtags, one or more relevant influencer content etc.). Further, in another implementation the user query may be a user intent of the user to receive an information related to the relevant product, the one or more relevant influencers, the one or more relevant digital contents and/or the like data. Further, in an instance, the user intent may be determined based on a user interaction data of the user associated with the digital media platform. Also, the user query is received at the transceiver unit [102] via the digital media platform and the digital media platform is accessed by the user via the user device. Furthermore, in an implementation the digital media platform is an ecommerce platform connected to one or more social media platforms and in another implementation the digital media platform is a social media platform connected to the one or more social media platforms, wherein such digital media platform (i.e., the social media platform) comprises the facilities similar to one or more ecommerce platforms such as the facility of buying and/or selling the products digitally.

The processing unit [104] is configured to, determine a personalization score corresponding to the user query based at least on an affinity of the user to one or more digital contents and one or more influencers present on the one or more social media platforms. More specifically, the personalization score corresponding to the user query is determined based at least on an affinity of the user to one or more topics translating to affinity of the user to the one or more digital contents and the one or more influencers present on the one or more social media platforms. For example, the user who has affinity to the topics ‘summer wear’ and ‘cartoons’ will see more digital content and influencers who also have affinity to the topics of ‘summer wear’ and ‘cartoon’. If the above user were to query red shirts, then personalization score will be computed on the relevant set of digital content and influencers matching “red shirts” basis the affinity each of the digital content and influencers have with the topics ‘summer wear’ and ‘cartoons’. The one or more digital contents further comprises at least one of one or more tags, one or more users content and one or more influencers content present on the one or more social media platforms. More specifically, the processing unit [104] is configured to determine, a personalization score corresponding to at least one of one or more users content associated with the user, one or more tags associated with the user, one or more influencers content associated with the user, one or more influencers associated with the user and one or more products associated with the user, to determine the personalization score corresponding to the user query. Furthermore, the one or more tags are connected to at least one of one or more products present on the one or more social media platforms, the one or more influencers, the one or more influencers content and the one or more users content based at least on a credibility associated with the one or more influencers. The credibility associated with the one or more influencers is considered as the one or more influencers are the primary and sole source of one or more tag associations i.e., the connection between the one or more tags and at least one of the one or more products, the one or more influencers, the one or more influencers content and the one or more users content present on the one or more social media platforms. For example, if an influencer and/or an influencer's content is directly (for instance via a metadata) and/or indirectly (for instance via an associated/tagged metadata) connected to tags/hashtags. In the case of products, given that there is no direct mode of associating a hashtag through a metadata, wherever the products are tagged to the influencer or the influencer's content, an indirect association of such products is considered with hashtags associated with the influencer or the influencer's content. Also, as the one or more tags are connected to at least one of the one or more products, the one or more influencers, the one or more influencers content and the one or more users content based at least on the credibility associated with the one or more influencers, a weight factor of the one or more influencers is considered to determine the personalization score corresponding to the user query.

Further, in an implementation the processing unit [104] is configured to determine the personalization score corresponding to the user query based on an affinity of the one or more tags to at least one of the one or more users content, the one or more products, the one or more influencers and the one or more influencers content present on the one or more social media platforms. For instance, in an implementation where the one or more influencers are the primary and sole source of one or more tag associations, an item's affinity to a given tag (i.e., a hashtag) through an influencer or an influencer tagged item (such as influencer content, influencer product, etc.) is influenced by the credibility of said influencer and therefore a weightage is given to the association between the item and the hashtag. For example, for a given hashtag Hi, A content Cn from influencer Im, the affinity αCnHi is the affinity between said content and said hashtag

α(CnHi)=Wm*β

where Wm is a weight of said influencer and β is a class weight (class=content, influencer, etc.). In an implementation the weight factor for each influencer is determined based on said influencer's tier on the one or more social media platforms which further depends on the influencer's journey and interaction on the one or more social media platforms.

Also, in another implementation the processing unit [104] is further configured to determine the personalization score corresponding to the user query based on at least one of an affinity between two or more tags and an affinity between two or more products, wherein each product of the two or more products is one of a tagged (i.e., product associated with the one or more tags) and a non-tagged product (i.e., product that are yet to be associated with the one or more tags). Also, in an example an item-to-item affinity between products that are tagged and products which are yet to be tagged is used to build a product hashtag affinity to determine a personalization score corresponding to a user query.

Furthermore, the affinity between two or more tags (for instance hashtag to hashtag affinity) is also determined based on co-tagging of the two or more tags (hashtags) to at least one of the one or more influencers, the one or more influencers content, and the one or more products. Furthermore, in an implementation, user's hashtag affinity is also determined based on user's interaction on the one or more social media platforms with at least one of the one or more products, the one or more users content, the one or more influencers content, the one or more influencers, and the one or more tags.

Further in an example for determining a search ranking specifically, to determine/provide a relevant product/information, for a given query from user Ut, all items (such as one or more digital contents, influencers, products, and hashtags) corresponding to the user query are retrieved. Then for the given user Ut, personalization score for each item is computed as follows (in this example personalization score for a set of content items)

P(Ut,Cr)=Σ_(i=1)\hat{ }nα(UtHi)*α(CrHi)

where P(Ut,Cr) is the personalization score for a user Ut associated with a content Cr, and H1, H2 , . . . Hi . . . Hn are the hashtags associated with the user. α(UtHi) is the affinity between the user and a given hashtag and a(CrHi) is the affinity between the relevant content and the same hashtag. Similar personalization scores between users and other items such as influencers, products, etc., can be determined.

Thereafter the processing unit [104] is configured to determine a diversification score corresponding the one or more digital contents. More particularly, the processing unit [104] is further configured to determine a diversification score for the one or more products associated with at least one of the one or more tags, the one or more influencers and the one or more influencers content, to determine the diversification score corresponding the one or more digital contents, wherein the determination is based at least on an information related to tagging of the one or more products with at least one of the one or more tags, the one or more influencers and the one or more influencers content. In an example, the information related to tagging of the one or more products comprises a data related to a number of times the one or more products is tagged by the one or more influencers to at least one of the one or more tags, the one or more influencers and the one or more influencers content. In an example, suppose a product P is purchased after iteration t, the diversification score for the product P tagged to a content is computed as follows:

D(Pt, Ct)=μ*p*Z+α√/(2 log t/it)

Where D is the diversification score for a product Pt tagged to a content Ct at iteration t. μ is the mean of the number of times a product Pt is tagged to content Ct, p is the price of the product Pt, Z is a normalization factor and it is the impression count of product Pt at iteration t.

Similarly, diversification score for products tagged to hashtags by influencers can be calculated.

Further the processing unit [104] is configured to determine a relevance score of one or more standard relevance parameters corresponding to the user query. In an implementation each of the one or more standard relevance parameter is one of a performance parameter, quality parameter and speed parameter. Also, in another implementation the each of the one or more standard relevance parameter may also encompasses parameters such as to indicate freshness, trendiness, fulfilment, commerce etc. Furthermore, the processing unit [104] is configured to determine one or more standard relevance parameters for at least one of the one or more digital contents, the one or more products and the one or more influencers, to determine the relevance score of the one or more standard relevance parameters corresponding to the user query. The relevance score of the one or more standard relevance parameters indicates relevance of at least one of the one or more digital contents, the one or more products and the one or more influencers to the user query. Furthermore, in an example, a performance parameter for an influencer may be determined based on influencer's engagement on one or more social media platforms. The influencer's engagement may be determined based on views per impression and/or store/profile visits per impression. Once the performance parameter for the influencer is determined, a relevance score of the performance parameter for the influencer is then determined by the processing unit [104]. In another example, the quality parameter for at least one of the one or more digital contents, the one or more products and the one or more influencers may be determined based at least on reliability of at least one of the one or more digital contents, the one or more products and the one or more influencers on the one or more social media platforms. Further, in an example the reliability is determined based on one or more parameters such as including but not limited to likes, share, follows, reporting and other such factors associated with quality of at least one of the one or more digital contents, the one or more products and the one or more influencers on the one or more social media platforms. For example, a quality score for an influencer can be determined based on one or more parameters of reliability/quality of the influencer store (i.e. follows, reports (-ve factor), a weekly content upload rate, time spent per store visit, product page views (PPVs) per store visits) and one or more parameters associated via a quality score of one or more tagged content and/or products. Therefore, the quality score for the influencer provided as:

Inf Quality score ∝(ΣDirect quality parameters+ΣTagged product/content quality score)

In another example, a quality score for other non-product items such as the one or more digital content (i.e. at least one of the one or more tags, the one or more users content and the one or more influencers content present on the one or more social media platforms) and the like can be determined in a similar manner as disclosed in the above example.

Also, the processing unit [104] is thereafter configured to determine a ranking score corresponding to the user query based at least on the personalization score, the diversification score and the relevance score. In an implementation, the ranking score corresponding to the user query is determined as:

φ(s)=Wr*R(s)+Wp*P(s)+Wd*D(s)+We*E(s)+Wq*Q(s)+Wc*C(s)

where Wr, Wp, Wd, We, Wq, Ws are weights for different ranking factors/parameters i.e. relevance score R(s) of the one or more standard relevance parameters, personalization score P(s), diversification score D(s), performance score E(s), quality score Q(s) and commerce score C(s) related to factors such as speed, fulfilment, etc., respectively. Also, in the given implementation R(s) may be relevance score of any standard relevance parameter other than that of the performance, quality and commerce parameters.

Also, the same can be summarized as below:

φ(s)=Σ(Wi*Fi)

Where, Wi is the weight for each factor/parameter and Fi is the score/score parameter for each factor/parameter. In another implementation, there could be additional factors such as those to indicate freshness, trendiness etc.

The processing unit [104] is further configured to provide via the digital media platform, the relevant product in response to the user query based on the ranking score corresponding to the user query. For example, if a user query is related to a Red Color Shoe, the processing unit [104] is configured to provide via the digital media platform, one or more Red Color Shoe based on a ranking score determined for said user query related to the Red Color Shoe. Furthermore, the ranking score is determined based on a personalization score corresponding to the user query related to the Red Color Shoe, a diversification score related to one or more red color shoe present on a digital media platform and a relevance score of one or more standard relevance parameters corresponding to the user query related to the Red Color Shoe.

Also, the processing unit [104] is configured to provide via the digital media platform, an information of at least one of one or more relevant digital contents and one or more relevant influencers based on the ranking score corresponding to the user query. Furthermore, the one or more relevant digital contents includes but not limited to one or more relevant tags, one or more relevant users content and one or more relevant influencers content present on the one or more social media platforms. For example, if a user query is related to a hashtag #ABCShirt, the processing unit [104] is configured to provide via the digital media platform, an information of one or more relevant hashtags (i.e. hashtag/s relevant to the user query related to the hashtag #ABCShirt) based on a ranking score determined for said user query. Furthermore, the ranking score is determined based on a personalization score corresponding to said user query related to the hashtag #ABCShirt, a diversification score related to one or more products tagged to the hashtag #ABCShirt present on a digital media platform and a relevance score of one or more standard relevance parameters corresponding to the user query related to the hashtag #ABCShirt (for instance, a quality parameter of the hashtag #ABCShirt).

Thereafter, the processing unit [104] is further configured to optimize the ranking score based on one or more events related to the one or more digital contents. In an implementation, the one or more events may further indicate at least one of an engagement parameter (such as Click-Through Rate (CTR)) and a conversion parameter (such as Revenue per impression (RPI)) related to at least one of the one or more digital contents and the one or more products. Also, in an example, a ranking score can be optimized as:

φ(O)=λ*(CTR)+(1−λ)*(RPI)

where λ∈{0,1}. Also, λ represents a weight given between the two events related to the one or more digital contents i.e. an engagement parameter and a conversion parameter. In an event λ is dependent on finer strategies of the digital media platform and can vary for different digital contents. Also, in an implementation, it can change, depending on a context indicating whether it is a normal day or sales event day. Hence λ provides optimization of the ranking score.

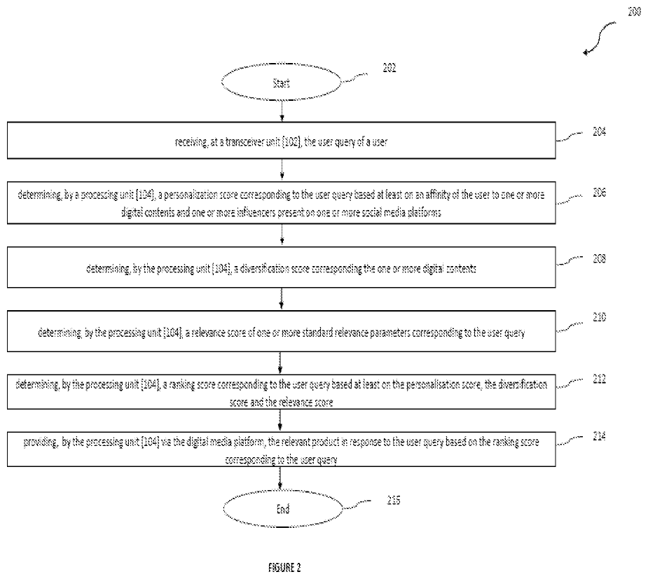

Referring to FIG. 2, an exemplary method flow diagram [200], depicting a method for providing a relevant product via a digital media platform, in response to a user query, in accordance with exemplary embodiments of the present invention is shown. In an implementation the method is implemented by the system [100]. As shown in FIG. 2, the method begins at step [202].

At step [204], the method comprises receiving, at a transceiver unit [102], the user query of a user. In an implementation the user query is a search query initiated by the user for searching at least a relevant product, via the digital media platform. Also, the user query may be initiated by the user to search an information of at least one of one or more relevant influencers and one or more relevant digital contents (such as one or more relevant hashtags and/or influencer contents). Further, in another implementation the user query may be a user intent of the user to receive an information related to the relevant product, the one or more relevant influencers, the one or more relevant digital contents and/or the like data. Further, in an instance, the user intent may be determined based on a user interaction data of the user associated with the digital media platform. Also, the user query is received at the transceiver unit [102] via the digital media platform and the digital media platform is accessed by the user via the user device. Furthermore, in an implementation the digital media platform is an ecommerce platform connected to one or more social media platforms and in another implementation the digital media platform is a social media platform connected to the one or more social media platforms, wherein such digital media platform (i.e. the social media platform) comprises the facilities similar to one or more ecommerce platforms such as the facility to provide an option of buying and/or selling the products digitally.

Next, at step [206], the method comprises determining, by a processing unit [104], a personalization score corresponding to the user query based at least on an affinity of the user to one or more digital contents and one or more influencers present on the one or more social media platforms. More specifically, the personalization score corresponding to the user query is determined based at least on an affinity of the user to one or more topics translating to affinity of the user to the one or more digital contents and the one or more influencers present on the one or more social media platforms. The one or more digital contents further comprises at least one of one or more tags, one or more users content (i.e. content posted by one or more users) and one or more influencers content present on the one or more social media platforms. More specifically, in an implementation the process of determining, by the processing unit [104], the personalization score corresponding to the user query further comprises determining, a personalization score corresponding to at least one of one or more users content associated with the user, one or more tags associated with the user, one or more influencers content associated with the user, one or more influencers associated with the user and one or more products associated with the user. Furthermore, the one or more tags are connected to at least one of one or more products present on the one or more social media platforms, the one or more influencers, the one or more influencers content and the one or more users content based at least on a credibility associated with the one or more influencers. The credibility associated with the one or more influencers is considered, as the one or more influencers are the primary and sole source of one or more tag associations i.e. the connection between the one or more tags and at least one of the one or more products, the one or more influencers, the one or more influencers content and the one or more users content present on the one or more social media platforms. For example, if an influencer and/or an influencer's content is directly (for instance via a metadata) and/or indirectly (for instance via an associated/tagged metadata) connected to tags/hashtags. In the case of a product, given that there is no direct mode of associating a hashtag through a metadata, wherever the product is tagged to the influencer or the influencer's content, an indirect association of such product is considered with hashtags associated with the influencer or the influencer's content. Also, as the one or more tags are connected to at least one of the one or more products, the one or more influencers, the one or more influencers content and the one or more users content based at least on the credibility associated with the one or more influencers, a weight factor of the one or more influencers is considered to determine the personalization score corresponding to the user query.

Further, in an implementation the process of determining, by the processing unit [104], the personalization score corresponding to the user query is further based on an affinity of the one or more tags to at least one of the one or more users content, the one or more products, the one or more influencers and the one or more influencers content present on the one or more social media platforms. For instance, in an implementation where the one or more influencers are the primary and sole source of one or more tag associations, an item's (such as a content's, a product's, etc.) affinity to a given tag (i.e. a hashtag) through an influencer or an influencer tagged item (such as influencer content, influencer product, etc.) is influenced by the credibility of said influencer and therefore a weightage is given to the association between the item and the hashtag. For example, for a given hashtag Hj, A content Cx from influencer In, the affinity aCxHj is the affinity between said content and said hashtag

α(CxHj)=Wm*β

where Wm is a weight of said influencer and β is a class weight (class=content, influencer, etc.). In an implementation the weight factor for each influencer is determined based on said influencer's tier on the one or more social media platforms which further depends on the influencer's journey and interaction on the one or more social media platforms.

Also, in another implementation the process of determining, by a processing unit [104], a personalization score corresponding to the user query is further based on at least one of an affinity between two or more tags and an affinity between two or more products, wherein each product of the two or more products is one of a tagged (i.e., product associated with the one or more tags) and a non-tagged product (i.e. product that is yet to be associated with the one or more tags). Also, in an example an item-to-item affinity between products that are tagged and products which are yet to be tagged is used to build a product hashtag affinity to determine a personalization score corresponding to a user query. Furthermore, the affinity between two or more tags (for instance hashtag to hashtag affinity) is also determined based on co-tagging of the two or more tags (hashtags) to at least one of the one or more influencers, the one or more influencers content, and the one or more products. Furthermore, in an implementation, user's hashtag affinity is also determined based on user's interaction on the one or more social media platforms with at least one of the one or more products, the one or more users content, the one or more influencers content, the one or more influencers, and the one or more tags.

Further in an example for determining a search ranking specifically, to determine/provide a relevant product/information, for a given query from user Uj, all items (such as one or more digital contents, influencers, products, and hashtags) corresponding to the user query are retrieved. Then for the given user Uj, personalization score for each item is computed as follows (in this example personalization score for a set of content items)

P(Uj,Cr)=Σ(i=1)\hat{ }nα(UjHi)*α(CrHi)

where P(Uj,Cr) is the personalization score for a user Uj associated with a content Cr, and H1, H2, . . . Hi . . . Hn are the hashtags associated with the user. α(UjHi) is the affinity between the user and a given hashtag and α(CrHi) is the affinity between the relevant content and the same hashtag. Similar personalization scores between users and other items such as influencers, products, etc., can be determined.

Thereafter, at step [208], the method comprises determining, by the processing unit [104], a diversification score corresponding the one or more digital contents. More specifically, the determining, by the processing unit [104], a diversification score corresponding the one or more digital contents further comprises determining a score for the one or more products associated with at least one of the one or more tags, the one or more influencers and the one or more influencers content, wherein the determination is based at least on an information related to tagging of the one or more products with at least one of the one or more tags, the one or more influencers and the one or more influencers content. In an example, the information related to tagging of the one or more products comprises a data related to a number of times the one or more products is tagged by the one or more influencers to at least one of the one or more tags, the one or more influencers and the one or more influencers content. In an example, if a product A is purchased after iteration j, the diversification score for the product A tagged to a content is computed as follows:

D(Aj, Cj)=μ*p*Z+α√/(2 logt/ij)

Where D is the diversification score for a product Aj tagged to a content Cj at iteration j. μ is the mean of the number of times a product Aj is tagged to content Cj, p is the price of the product Aj, Z is a normalization factor and ij is the impression count of product Aj at iteration j.

Similarly, diversification score for products tagged to hashtags by influencers can be calculated.

Next, at step [210], the method comprises determining, by the processing unit [104], a relevance score of one or more standard relevance parameters corresponding to the user query. Also, each of the one or more standard relevance parameter is one of a performance parameter, quality parameter and speed parameter. Also, in an implementation the each of the one or more standard relevance parameter may also encompasses parameters such as to indicate at least one of freshness, trendiness, fulfilment, commerce and the like details. Further, the process of determining, by the processing unit [104], a relevance score of one or more standard relevance parameters corresponding to the user query, further comprises determining one or more standard relevance parameters for at least one of the one or more digital contents, the one or more products and the one or more influencers. The relevance score of the one or more standard relevance parameters indicates relevance of at least one of the one or more digital contents, the one or more products and the one or more influencers to the user query.

Furthermore, in an example, a performance parameter for an influencer may be determined based on influencer's engagement on one or more social media platforms. The influencer's engagement may be determined based on views per impression and/or store/profile visits per impression. Once the performance parameter for the influencer is determined, the method encompasses determining by the processing unit [104], a relevance score of the performance parameter for the influencer. In another example, the quality parameter for at least one of the one or more digital contents, the one or more products and the one or more influencers may be determined based at least on reliability of at least one of the one or more digital contents, the one or more products and the one or more influencers respectively, on the one or more social media platforms. Further, in an example the reliability is determined based on one or more parameters such as including but not limited to likes, share, follows, reporting and other such factors associated with quality of at least one of the one or more digital contents, the one or more products and the one or more influencers on the one or more social media platforms. For example, a quality score for an influencer can be determined based on one or more parameters of reliability/quality (i.e., follows, reports, a weekly content upload rate, time spent per store visit, product page views (PPVs) per store visits) of the influencer store and one or more parameters associated via a quality score of one or more tagged content and/or products. Therefore, the quality score for the influencer provided as:

Inf Quality score ∝(ΣDirect quality parameters+ΣTagged product/content quality score)

Also, in another example, a quality score for other non-product items such as the one or more digital content (i.e., at least one of the one or more tags, the one or more users content and the one or more influencers content present on the one or more social media platforms) and the like can be determined in a similar manner as disclosed in the above example.

Further, at step [212], the method comprises determining, by the processing unit

, a ranking score corresponding to the user query based at least on the [104]rsonalization score, the diversification score and the relevance score. In an implementation, the ranking score corresponding to the user query is determined as:

φ(s)=Wr*R(s)+Wp*P(s)+Wd*D(s)+We*E(s)+Wq*Q(s)+Wc*C(s)

where Wr, Wp, Wd, We, Wq, Ws are weights for different ranking factors/parameters i.e., relevance score R(s) of the one or more standard relevance parameters, personalization score P(s), diversification score D(s), performance score E(s), quality score Q(s) and commerce score C(s), respectively. Also, in the given implementation R(s) may be relevance score of any standard relevance parameter other than that of the performance, quality and commerce parameters.

Also, the same can be summarized as below:

φ(s)=Σ(Wi*Fi)

Where, Wi is the weight for each factor/parameter and Fi is the score/score parameter for each factor/parameter. In another implementation, there could be additional parameters such as those to indicate freshness, trendiness etc.

Thereafter, at step [214], the method comprises providing, by the processing unit [104] via the digital media platform, the relevant product in response to the user query based on the ranking score corresponding to the user query. For example, if a user query is related to a XYZ Shirt, the method encompasses providing by the processing unit [104] via the digital media platform, one or more XYZ Shirts (as a relevant XYZ shits) based on a ranking score determined for said user query related to the XYZ Shirt. Furthermore, the ranking score is determined based on a personalization score corresponding to the user query related to the XYZ Shirt, a diversification score related to one or more XYZ Shirts present on a digital media platform and a relevance score of one or more standard relevance parameters corresponding to the user query related to the XYZ Shirt.

Also, the method further comprises providing, by the processing unit [104] via the digital media platform, an information of at least one of one or more relevant digital contents and one or more relevant influencers based on the ranking score corresponding to the user query. Furthermore, the one or more relevant digital contents includes but not limited to one or more relevant tags, one or more relevant users content and one or more relevant influencers content present on the one or more social media platforms. For example, if a user query is related to an influencer A, the method comprises providing, by the processing unit [104] via the digital media platform, an information of one or more relevant influencers (i.e., influencer/s relevant to the user query related to the influencer A) based on a ranking score determined for said user query. Furthermore, the ranking score is determined based on a personalization score corresponding to said user query related to the influencer A, a diversification score related to one or more products tagged to at least one of a content posted by the influencer A (influencer A content) and the influencer A on a digital media platform and a relevance score of one or more standard relevance parameters corresponding to the user query related to the influencer A (for instance, a performance parameter of the influencer A).

The method further comprises optimizing the ranking score based on one or more events related to the one or more digital contents. In an implementation, the one or more events may further indicate at least one of an engagement parameter (such as Click-Through Rate (CTR)) and a conversion parameter (such as Revenue per Impression (RPI)) related to at least one of the one or more digital contents and the one or more products. Also, in an example, a ranking score can be optimized based on:

φ(O)=λ*(CTR)+(1−λ)*(RPI)

where λ∈{0,1}. Also, λ represents a weight given between the two events related to the one or more digital contents i.e., an engagement parameter and a conversion parameter. In an event λ is dependent on finer strategies of the digital media platform and can vary for different digital contents. Also, in an implementation, it can change, depending on a context indicating whether it is a normal day or sales event day. Hence λ provides optimization of the ranking score.

Thereafter, the method terminates at step [216].

As is evident from the above disclosure, the present invention provides a novel solution for providing a relevant product via a digital media platform, in response to a user query. Also, the present invention provides a solution for providing an information based on personalization, diversification, and ranking of a search result (such as products/influencers/influencers contents etc.) on a digital media platform. Furthermore, the present invention provides a solution to determine a personalization score corresponding to a user query based on user affinities to digital content and/or tags (i.e., hashtags), to further provide personalized search results in response to the user query. The present invention also provides a solution for diversification problems related to digital search of an information based on a diversification score determined for such digital search. Moreover, the present invention provides a solution of providing an efficient and effective information/product to the users in response to one or more user queries, based on a combination of one or more personalization and diversification parameters with traditional search ranking parameters. The present invention also provides a solution to provide ranking of a product/digital content/influencer based on personalization and diversification parameters such as by considering different weights for personalization parameters, diversification parameters, and standard relevance parameters.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for providing a relevant product via a digital media platform, in response to a user query, the method comprising:
receiving, at a transceiver unit [102], the user query of a user;
determining, by a processing unit [104], a personalization score corresponding to the user query based at least on an affinity of the user to one or more digital contents and one or more influencers present on one or more social media platforms;
determining, by the processing unit [104], a diversification score corresponding the one or more digital contents;
determining, by the processing unit [104], a relevance score of one or more standard relevance parameters corresponding to the user query;
determining, by the processing unit [104], a ranking score corresponding to the user query based at least on the personalization score, the diversification score and the relevance score; and
providing, by the processing unit [104] via the digital media platform, the relevant product in response to the user query based on the ranking score corresponding to the user query.

2. The method as claimed in claim 1, wherein the one or more digital contents further comprises at least one of one or more tags, one or more users content and one or more influencers content present on the one or more social media platforms.

3. The method as claimed in claim 2, wherein determining, by a processing unit , a personalization score corresponding to the user query further comprises determining, a personalization score corresponding to at least one of one or more users content associated with the user, one or more tags associated with the user, one or more influencers content associated with the user, one or more influencers associated with the user and one or more products associated with the user.

4. The method as claimed in claim 2, wherein the one or more tags are connected to at least one of one or more products present on the one or more social media platforms, the one or more influencers, the one or more influencers content and the one or more users content based at least on a credibility associated with the one or more influencers.

5. The method as claimed in claim 4, wherein the determining, by a processing unit [104], a personalization score corresponding to the user query is further based on an affinity of the one or more tags to at least one of the one or more users content, the one or more products, the one or more influencers and the one or more influencers content present on the one or more social media platforms.

6. The method as claimed in claim 5, wherein the determining, by a processing unit [104], a personalization score corresponding to the user query is further based on at least one of an affinity between two or more tags and an affinity between two or more products, wherein each product of the two or more products is one of a tagged and a non-tagged product.

7. The method as claimed in claim 1, wherein the determining, by the processing unit [104], a diversification score corresponding the one or more digital contents further comprising determining a diversification score for the one or more products associated with at least one of the one or more tags, the one or more influencers and the one or more influencers content, wherein the determination is based at least on an information related to tagging of the one or more products with at least one of the one or more tags, the one or more influencers and the one or more influencers content.

8. The method as claimed in claim 1, wherein each of the one or more standard relevance parameter is one of a performance parameter, quality parameter and speed parameter.

9. The method as claimed in claim 1, wherein determining, by the processing unit [104], a relevance score of one or more standard relevance parameters corresponding to the user query, further comprises determining one or more standard relevance parameters for at least one of the one or more digital contents, the one or more products and the one or more influencers.

10. The method as claimed in claim 1, the method further comprises optimizing the ranking score based on one or more events related to the one or more digital contents.

11. The method as claimed in claim 1, the method further comprises providing, by the processing unit [104] via the digital media platform, an information of at least one of one or more relevant digital contents and one or more relevant influencers based on the ranking score corresponding to the user query.

12. A system for providing a relevant product via a digital media platform, in response to a user query, the system comprising:
a transceiver unit [102], configured to receive, the user query of a user;
a processing unit [104], configured to, determine:
a personalization score corresponding to the user query based at least on an affinity of the user to one or more digital contents and one or more influencers present on one or more social media platforms,
a diversification score corresponding the one or more digital contents,
a relevance score of one or more standard relevance parameters corresponding to the user query, and
a ranking score corresponding to the user query based at least on the personalization score, the diversification score and the relevance score; wherein:
the processing unit [104] is further configured to provide via the digital media platform, the relevant product in response to the user query based on the ranking score corresponding to the user query.

13. The system as claimed in claim 12, wherein the one or more digital contents further comprises at least one of one or more tags, one or more users content and one or more influencers content present on the one or more social media platforms.

14. The system as claimed in claim 13, wherein the processing unit [104] is further configured to determine, a personalization score corresponding to at least one of one or more users content associated with the user, one or more tags associated with the user, one or more influencers content associated with the user, one or more influencers associated with the user and one or more products associated with the user, to determine the personalization score corresponding to the user query.

15. The system as claimed in claim 13, wherein the one or more tags are connected to at least one of one or more products present on the one or more social media platforms, the one or more influencers, the one or more influencers content and the one or more users content based at least on a credibility associated with the one or more influencers.

16. The system as claimed in claim 15, wherein the processing unit [104] is further configured to determine the personalization score corresponding to the user query based on an affinity of the one or more tags to at least one of the one or more users content, the one or more products, the one or more influencers and the one or more influencers content present on the one or more social media platforms.

17. The system as claimed in claim 16, wherein the processing unit [104] is further configured to determine the personalization score corresponding to the user query based on at least one of an affinity between two or more tags and an affinity between two or more products, wherein each product of the two or more products is one of a tagged and a non-tagged product.

18. The system as claimed in claim 12, wherein the processing unit [104] is further configured to determine a score for the one or more products associated with at least one of the one or more tags, the one or more influencers and the one or more influencers content, to determine the diversification score corresponding the one or more digital contents, wherein the determination is based at least on an information related to tagging of the one or more products with at least one of the one or more tags, the one or more influencers and the one or more influencers content.

19. The system as claimed in claim 12, wherein each of the one or more standard relevance parameter is one of a performance parameter, quality parameter and speed parameter.

20. The system as claimed in claim 12, wherein the processing unit [104] is further configured to determine one or more standard relevance parameters for at least one of the one or more digital contents, the one or more products and the one or more influencers, to determine the relevance score of the one or more standard relevance parameters corresponding to the user query.

21. The system as claimed in claim 12, wherein the processing unit [104] is further configured to optimize the ranking score based on one or more events related to the one or more digital contents.

22. The system as claimed in claim 12, wherein the processing unit [104] is further configured to provide, via the digital media platform, an information of at least one of one or more relevant digital contents and one or more relevant influencers based on the ranking score corresponding to the user query.
